(19) United States
(12) Patent Application Publication
(10) Pub. No.: US 2014/0187197 A1
(43) Pub. Date: Jul. 3, 2014

(54) METHOD AND SYSTEM FOR PROVIDING REAL-TIME ACCESS TO MOBILE COMMERCE PURCHASE CONFIRMATION EVIDENCE

(71) Applicant: Alan SEGE, Los Angeles, CA (US)

(72) Inventor: Alan SEGE, Los Angeles, CA (US)

(21) Appl. No.: 14/201,468

(22) Filed: Mar. 7, 2014

Related U.S. Application Data
(63) Continuation of application No. 12/794,583, filed on Jun. 4, 2010, now abandoned.

(51) Int. Cl. H04W 4/24; H04W 12/06

(52) U.S. Cl. CPC H04W 4/24; H04W 12/06
USPC 455/406

(57) ABSTRACT

A method and system are provided for providing a real-time access to mobile commerce payment evidence. The method includes receiving and storing evidence that a mobile handset user has confirmed his intention of making a purchase to be billed to his mobile operator account. The method further includes authenticating the confirmation received, and storing evidence of that authentication. Further, the method includes providing at least some of that evidence to at least one of the subscriber, the utility provider, and a provider of the product purchased.

### CLAIM OF PRIORITY UNDER 35 U.S.C. §120

The present Application for Patent is a continuation of U.S. Utility application Ser. No. 12/794,583 entitled “METHOD AND SYSTEM FOR PROVIDING REAL-TIME ACCESS TO MOBILE COMMERCE PURCHASE CONFIRMATION EVIDENCE” filed on Jun. 4, 2010, pending, and assigned to the assignee hereof, the entire contents of which are incorporated by reference herein.

### BACKGROUND OF THE INVENTION

1. Field of the Invention

The present invention relates to mobile commerce in general. More specifically, the present invention relates to a method and system for providing a real-time access to evidence of mobile commerce payments.

2. Description of the Related Art

Public mobile network operators earn a substantial portion of their revenues by permitting third party merchants to sell content or services to their subscribers. The subscribers in turn are billed for the third party content or third party services on their individual mobile phone bill. Examples of such mobile network operators include, but are not limited to, AT&T Mobility, Verizon Wireless, Sprint PCS, and T-Mobile. The mobile network operators retain a significant portion of the third party charges as a “revenue share” or a transaction fee.

Recently, the mobile network operators introduced a two-factor fraud prevention mechanism known as “double opt-in” to ensure that mobile subscribers in fact had themselves knowingly decided to purchase the third party content or service and have it billed to their the bill corresponding to their own mobile handset.

In one incarnation of the known double opt-in method, a mobile user is typically presented with a promotion on a World Wide Web (www) page for a third party content or services. To complete the purchase and have it billed to his mobile phone bill, the user is presented with a description of the services he is purchasing and their price twice and also is required to prove that he in fact is in possession of the mobile handset being billed at the time of purchase. To achieve this, the steps of a typical state of the art double opt-in method are:

1) the user enters phone number of his mobile handset into a web-based form, which prominently displays the price and the description of the services; 2) a third party merchant's transactional system generates a special message, which typically includes a random PIN number (usually 4-6 digits or letters), and sends it via text message in the mobile operator network's messaging channel, to the user's mobile phone itself, the message typically also including a description of the service and the price; 3) to effect the purchase, the user is required to type that same PIN number into a succeeding page (called PIN verification page) in that same website in a blank field, which also is proximate to a display of a description of the service and the price; 4) the third party merchant's system recognizes the current validity of the PIN (that it is the same as the one just sent to the user's mobile phone) and then books the sale through the mobile network operator so that the charge may appear on the user's mobile phone bill.

Another form of double opt-in, known as mobile-originated opt-in, typically is used when these third party services are marketed by non-interactive advertisements on television, billboards, newspapers and the like. In a famous example, in 2010, the First Lady Michelle Obama appeared in a popular television commercial urging viewers to make mobile donations to aid Haiti earthquake victims. The commercial urged viewers to text the word “GIVE” to the short telephone number “90999.” When a viewer did this step, they would receive a reply from the charity organization, advising them that their mobile bill would be charged $10, and requiring that they confirm by replying with the word, “YES.” Once the charity received that confirmation, they would book that donation, and cause the charge to be billed to the handset holder's mobile phone bill.

To avoid the complication of working with virtually unlimited numbers of third-party web-based merchants and charities, mobile network operators typically contract responsibility to a trusted partner with expertise in mobile telecommunications, billing, consumer protection and customer support, known in the trade as an “aggregator” or a “messaging aggregator” or a “billing aggregator.” An aggregator's typical responsibilities include submitting charges and sending messages and content to mobile subscriber handsets. From the perspective of merchants and charities, working through aggregators permits them to avoid the complication of establishing high speed direct telecommunications links with all of the operators in a given geographical area.

Well-known aggregators include, but are not limited to, mQube (a Mobile Messenger company), Mblox, and OpenMarket (a division of Amdocs). A mobile network operator's contract with an aggregator presumably requires that the aggregator take full responsibility for ensuring that all third party charges are authorized under the operator's double-opt-in rules. And in turn, the aggregator contract with the third party web-based merchants presumably similarly requires that the third party web-based merchants only forward charges once the user has validly completed the double-opt-in process with respect to each forwarded charge.

Thus, the state of the art system relies on a chain of commercial contracts made from a third party merchant to an aggregator to a mobile network operator. Further complicating the exercise of enforcing anti-fraud measures is the fact that often merchants or charities will outsource the technical tasks of interacting with aggregator systems to billing organizations or technology or advertising service providers.

Problems arise when mobile users do not recall authorizing a charge, or when a mobile subscriber is mistakenly charged, and subsequently, the mobile subscriber calls the mobile network operator to cancel the unwanted service or obtain a refund. In such cases, there often is no way for the mobile network operator to verify in real-time whether or not the mobile subscriber did, in fact, make the third party content purchase. And, unlike online banking for checking accounts that often display cancelled checks, when viewing his mobile phone bill, the mobile subscriber also has no way to verify that in fact he did effect the purchase. Presumably, when a mobile subscriber actually calls the mobile network operator to question such a charge, the mobile subscriber learns that generally, unknown third party aggregators and third party web-based merchants have assured the mobile network operator that the purchase was genuine. But all too often, that does not provide the subscriber with a feeling of assurance.

To overcome the problem, some mobile network operators have suggested that the mobile network operator itself would actually intercede in each third party content purchase, such that the mobile network operator itself would be required to transmit to a mobile subscriber's web browser the PIN confirmation page. The advantage of an operator-run system is that it provides a mobile network operator the capability (“PIN tracking”) to track double-opt-in confirmation evidence in concert with its billing to its subscribers. But the approach also has insurmountable drawbacks insofar as 1) it pulls mobile operators, who prefer to remain neutral, into the stream of commerce and marketing for third party products and content that they do not control threatening their posture as a common carrier without liability for the contents of their carriage. Moreover, the approach interferes with the subscriber's shopping experience, causes inconvenience, and interferes with a merchant's freedom and ability to market and maintain a relationship with his customers.

In the light of the foregoing discussion, there is a need for a method and system which brings operators and mobile subscribers transparency into their mobile-billed purchases of third party goods and services. Further, there is a need for a method and system which can provide mobile network operators with a real-time access to the verification of the actual evidence of each subscriber's mobile-billed purchase, showing the precise time place and manner in which the double opt-in procedure occurred. Additionally, there is a need for a method and system through which mobile subscribers will be privy to the same level of transparency and records of their mobile commerce purchases, as that provided by the best forms of online banking, akin to the ability to view cancelled checks online.

### SUMMARY

Accordingly, it is an object of the present invention to provide a method and system for bringing consumers and operators transparency into third party content purchases by mobile subscriber billing.

It is another object of the present invention to provide a method and system for providing mobile network operators with a real-time access to actual evidence of the consumer's action to effect of each charge for a third party content or service purchase, including the PIN verification resulting from a mobile subscriber's completing a double opt-in process.

It is yet another object of the present invention to provide a method and system for providing mobile subscribers and operators with transparency to the verification of the mobile commerce purchases without disrupting the mobile or online shopping experience. The above and other objects of the present invention are achieved through a method and system for providing a real-time access to mobile evidence of the purchase and of the mobile user's double opt-in purchase confirmation. The system permits a mobile user to purchase third party content or services through the World Wide Web in a way that offers their own mobile operator, and ultimately the users themselves, transparent and real-time access to the evidence of their own actual purchase confirmation.

In an accordance with an aspect of the present invention, that purchase confirmation evidence (also called “PCE” herein) is available to mobile operators in real time, so that they can monitor it, access PCE of any particular transaction in real time or at any time, have available as needed to share with subscribers upon their request, or incorporate into their paper or online billing presentations.

In accordance with an aspect of the present invention, an aggregator hosts the PIN submit pages created by the third party merchants. In doing so, the aggregator is in control of the content of those pages to help ensure that price and terms are correctly disclosed. It also hosts the flow of messages and information entries into those purchase confirmation web pages, as well as the PIN messages and purchase confirmation messages sent through the operator's messaging channel to the handset. As part of its information interface with the mobile network operators, the aggregator provides a real-time-feed of PCE, or real-time access to those all aspects of the PCE for any or all transactions, to an operators billing or PIN tracking system.

In accordance with an aspect of the present invention, the method includes receiving a confirmation for payment from the subscriber for purchasing a third party product. The method further includes authenticating the confirmation received. Further, the method includes storing evidence of the confirmation received. Further, the method includes submitting the payment information for authorizing the payment from the subscriber account, where the subscriber account is an ongoing utility account with a mobile network operator. Finally, the method includes providing the PCE to at least one of the subscriber, the mobile operator, and a provider of the product purchased.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 illustrates a Prior art process flow under which a mobile network operator has no access to purchase confirmation evidence.

FIG. 2 shows a block diagram of a system for providing a real-time access to mobile commerce payment evidence, in accordance with an aspect of the present invention.

FIG. 3 shows a flow chart of a method for providing a real-time access to mobile commerce payment evidence, in accordance with an aspect of the present invention.

FIG. 4 shows a flow chart of a method for providing a real-time access to mobile commerce payment evidence, in accordance with another aspect of the present invention.

FIG. 5 illustrates a process flow under which a mobile network operator has access to purchase confirmation evidence, in accordance with an aspect of the present invention.

FIG. 6 illustrates a network environment in which various aspects of the invention can be practiced.

FIG. 7 illustrates a process flow under which a mobile network operator has access to purchase confirmation evidence, in accordance with another aspect of the present invention.

FIG. 8 illustrates a process flow under which a mobile network operator has access to purchase confirmation evidence, in accordance with yet another aspect of the present invention.

FIG. 9 illustrates a process flow under which a mobile network operator has access to purchase confirmation evidence, in accordance with yet another aspect of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects of the present invention.

### DETAILED DESCRIPTION

Before describing in detail the particular method and system for providing a real-time access to mobile commerce purchase confirmation evidence (“PCE”) in accordance with an aspect of the present invention, it should be observed that the present invention resides primarily in combinations of method and system components related to communication device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The term “mobile operator” and “mobile carrier” are used interchangeably, and refer to any provider of a public utility, who has the capability both of interacting or communicating with its users or subscribers, and billing them on a periodic basis. The term “aggregator” and “trusted partner” are used interchangeably to refer to an entity that is able to send and receive information from third party merchants and mobile operators. The terms “content provider” and “merchant” are used interchangeably to refer to entities that are not mobile operators or mobile operator subscribers, but who market or sell goods or services to be billed to the user's mobile operator bill.

The present invention provides a method and system for providing a real-time access to mobile commerce PCE. The system permits a mobile subscriber to purchase third party content or services through the World Wide Web in a way that produces, stores, and makes available to mobile operators PCE of all phases of the user's purchase authentication or opt-in. Having established that PCE, aspects of the present invention permits mobile operators to monitor, access in real time, and make available to their subscribers, any of that PCE at any time.

In accordance with an aspect of the present invention, an aggregator hosts the PIN submission pages or opt-in pages normally created by third party merchants. In doing so, the aggregator is in control of the content of those pages to help ensure that price and terms are correctly disclosed. The aggregator also hosts the flow of messages and information entries into those purchase confirmation web pages, as well as the PIN messages and purchase confirmation messages sent through the operator's messaging channel to the handset. As part of its information interface with the mobile network operators, the aggregator provides a real-time-feed of PIN confirmation reports, or real-time access to those reports, to an operators billing or PIN tracking system.

In an aspect of the present invention, each report for each online purchase of third party goods and services would comprise:

The time that a user entered his cell phone number into a cell-phone-number submit website;

The time that a user's handset was sent a message, or other handset authentication means, through the operator's messaging channel or other operator-approved medium, and the actual contents of that message including such items as the unique PIN number and any additional text such as an advice of charge;

The time that such a PIN number was entered on a succeeding PIN-entry web page, and further information about the page possibly including a screenshot, or the URL of the web page;

The IP address or other identifying information about the PC or other web browsing device that accessed that web page;

The contents of any purchase confirmation or additional service message that was transmitted to the user's mobile handset as a result of the purchase;

The contents of any purchase-related message that was messaged back from the user's handset, including without limitation words such as “STOP,” “CANCEL,” “HELP,” or the like that could indicate that the user had questions or was interested in discontinuing the third party service or the purchase.

For clarity, presently, following two existing mechanisms are known in the art for website-based double opt-in, and, confirmation and monitoring regimes are associated with them:

1) Carrier-administered PIN sending and verification: All controls are in the hands of mobile operators. Content provider's job essentially becomes just capturing subscriber's input and forwarding it to a carrier for verification and further instructions. Certain operators have proposed their own system for monitoring subscriptions and verifying whether the correct PIN was entered during subscription/sale process. The drawback of this method is that the mobile network operator intercedes into a stream of commerce in a way that in some respects is deleterious to their normal common carrier role. Implementing such a system draws an operator closer to the role of actually being a merchant of the third party goods and services that are marketed through their communications channel, jeopardizing their business model and legal role of being a common carrier rather than a content merchant. Secondly, if each of several carriers in a given geographical area implemented their own purchase confirmation evidence control system, including hosting of opt-in web pages, each merchant would need to interact with all carriers separately, and design numerous duplicative online shopping websites to feed into each carrier separately. Further, the approach would require shoppers to go through several additional steps in order to complete a purchase, such as identifying their mobile operator, and being presented with a confusing purchase confirmation page that is not designed to relate to the goods or services they are buying, leading to a confusing shopping experience. Last, from the merchant's perspective, the interruptions and extra steps will lead to frustrated shoppers choosing not to complete their purchases, and lost business for the merchant.

2) Content provider-administered or Aggregator-administered PIN sending and verification without mobile operator notification or monitoring: This mechanism is somewhat the opposite of the operator-controlled method, and predominates the field today. The third party merchant or content provider has complete control over the opt-in and purchase confirmation process. The present invention does introduce improvements even in this regime.

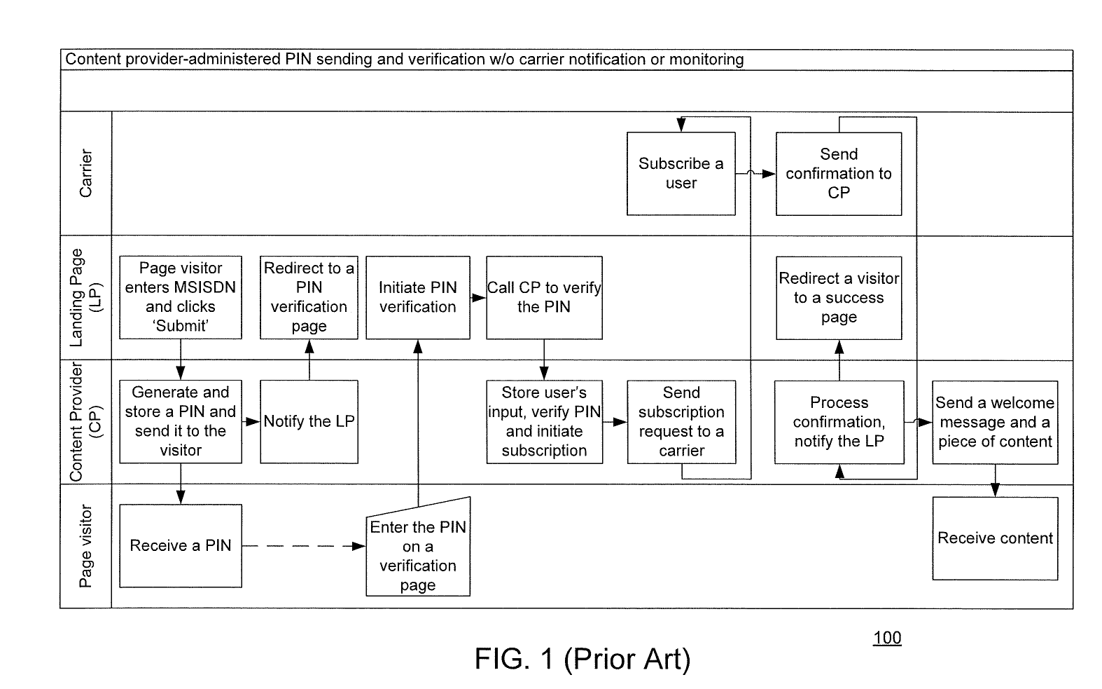

FIG. 1 illustrates such prior art process flow under which a mobile network operator has no access to purchase confirmation evidence. The PIN sending and verification process is controlled by content providers or aggregators.

The aggregators or third party content merchants under the present invention implement at least one of the following consumer protective features in their double opt in systems.

PIN Security:
a. PIN generation and verification algorithm that enables or permits ‘Master PINs’, i.e. PIN codes that are correct for all campaigns or clients regardless of web site user's input. Currently, many, if not most aggregator systems, do permit this master PIN feature, which threatens to be a back door escape for unscrupulous merchants.
b. The merchant's cell number submit page web servers being unaware of the PIN code that is generated and thus does not provide the vulnerability that a landing page could be spoofed or ‘hijacked’ in order to get a generated PIN number and enter it into the entry field or to bypass validation rules.

Subscription rules:
c. To avoid subscription fraud, if a PIN is entered incorrectly 3 times in a row, the ideal double opt-in system disables subscriber's ability to join the service for a period of time, say 24 hours.
d. To forbid the same user to subscribe to the same service more than once.
e. To forbid subscribing users who have not received and successfully validated PIN codes.

Data integrity:
f. Store all PIN sending and verification attempts along with dates, IP addresses and service information

Examples of aggregators or content providers who use the above mechanism include, but are not limited to, mQube, Mobile Messenger, SendMe Mobile and Funmobile all of whom develop solutions for subscription billing and individual purchases by double opt-in confirmed mobile billed purchase. The drawback of this mechanism is that the aggregators or content providers have not yet implemented means to make their PCE available to mobile operators and their actual subscribers. As a result, a mobile operator or subscriber wishing to review the PCE to confirm that they did, or confirm that they did not effect a purchase are forced to discover and make contact with the aggregator or Content Provider in order to request the PCE. And that PCE may not always be stored or available from the mobile operator. On the contrary, under normal circumstances, mobile users call their mobile operator with questions about their bill, and when it comes to third party charges, call center representatives of mobile operators do not have access to PCE in order to share it with their subscribers.

The present invention is a modified process of making a one-time sale of goods or services to be billed to a mobile phone, or subscribing a user to a recurring service that is billed to the mobile phone.

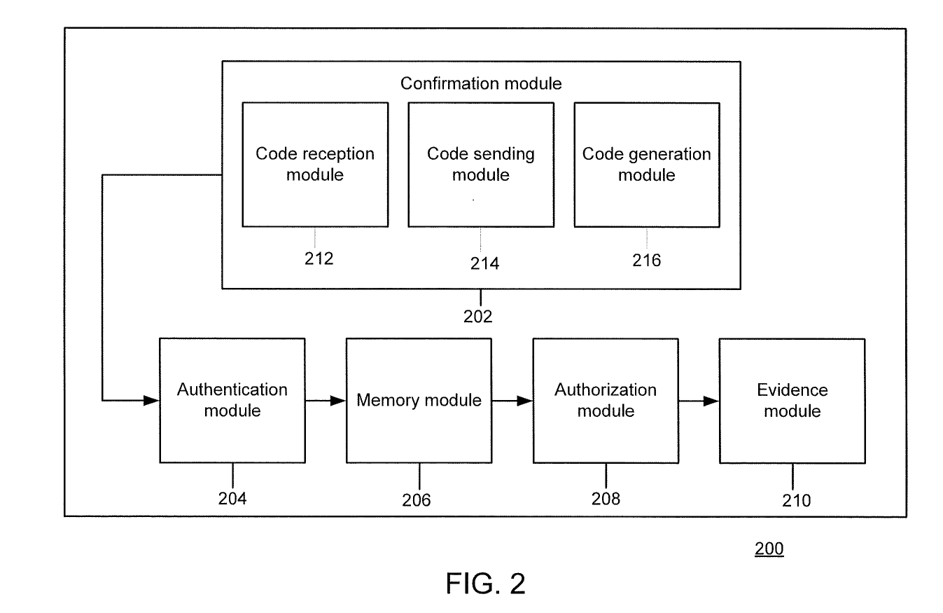

FIG. 2 shows a block diagram of a system 200 for providing a real-time access to mobile commerce purchase confirmation evidence, in accordance with an aspect of the present invention. The mobile commerce purchase is transacted from a subscriber account, where the subscriber account is an ongoing utility account with a mobile operator or any other telecommunications service provider, or utility provider with the ability to interact with its users and bill them. The system 200 includes a confirmation module 202, an authentication module 204, a memory module 206, an authorization module 208 and an evidence module 210.

In an aspect of the present invention, the confirmation module 202 is capable of receiving a confirmation for payment from the subscriber for purchasing a product, wherein the product is not provided by the utility provider.

Examples of the product include mobile content, mobile service, or even a physical product browsed through shopping website and the like. In an aspect of the present invention, the confirmation module 202 includes a code generation module 212, a code sending module 214 and a code reception module 216. The code generation module 212 is capable of generating a plurality of verification codes by one of random or pre-specified rules. When the subscriber sends a request to authorize the payment for the product, the code generation module 212 generates a verification code. Further, the code sending module 214 then sends that verification code of the plurality of verification codes to a communication device of the subscriber. The communication device is previously registered to receive the verification codes. Examples of the communication device include, but are not limited to, a mobile phone, a computer, a laptop, an e-book reader, a netbook, an iPad, a Kindle and a PDA. The code reception module 216 then receives a confirmation containing the verification code from the subscriber. The subscriber sends the verification code from the registered communication device. In another aspect of the present invention, the subscriber sends the verification code from an alternate communication device. The code reception module 216 can receive the verification code by one of a web page, a WAP page, a return message from the communication device, a phone call, a SMS message and a MMS message. In another aspect of the present invention, the confirmation module 202 includes a code database for storing the plurality of verification codes generated and status of verification of each verification code of the plurality of verification codes. In another aspect of the present invention the confirmation module 202 includes a notification module for notifying a remote observer about each of the plurality of verification codes and the verification results of each of the plurality of verification codes. The remote observer can be the subscriber, the mobile operator, an aggregator or a content provider of the product purchased.

In this aspect of the invention, the authentication module 204 is capable of authenticating the confirmation received by the confirmation module 202. The memory module 206 stores an evidence of the confirmation received. The evidence can include an evidence of sending a verification code to the subscriber, an evidence of subscriber action to the verification code sent, and an evidence of outcome of the confirmation received from the subscriber.

In a typical case, the PCE stored in memory module 206 can include:
The time that a user entered his cell phone number into a cell-phone-number submit website;
The time that a user's handset was sent a message, or other handset authentication means, through the operator's messaging channel or other operator-approved medium, and the actual contents of that message including such items as the unique PIN number and any additional text such as an advice of charge;
The time that such a PIN number was entered on a succeeding PIN-entry web page, and further information about the page possibly including a screenshot, or the URL of the web page;
The IP address or other identifying information about the PC or other web browsing device that accessed that web page;
The contents of any purchase confirmation or additional service message that was transmitted to the user's mobile handset as a result of the purchase;
The contents of any purchase-related message that was messaged back from the user's handset, including without limitation words such as “STOP,” “CANCEL,” “HELP,” or the like that could indicate that the user had questions or was interested in discontinuing the third party service or the purchase.

Further, the authorization module 208 submits the payment information for authorizing the payment from the subscriber account. The payment information includes the amount of payment and the product purchased. Finally, the evidence module 210 provides the evidence of the confirmation to at least one of the subscriber, the utility provider, and a provider of the product purchased.

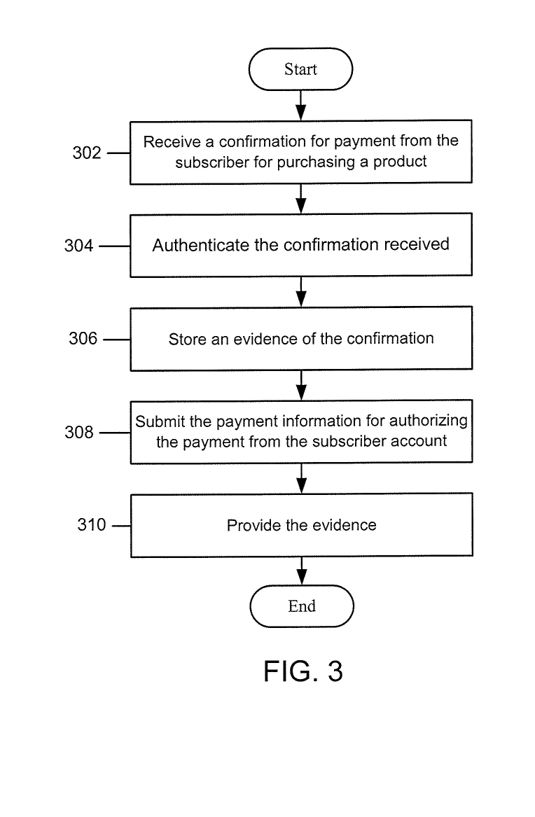

FIG. 3 shows a flow chart of a method for providing the utility operators (or mobile operators), users, or other authorized parties with real-time access to mobile commerce payment evidence, in accordance with an aspect of the present invention.

The mobile commerce payment is transacted from a subscriber account, where the subscriber account is an ongoing utility account with a mobile operator. At step 302, the system 200 receives a confirmation for payment from the subscriber for purchasing a product, where the product is not provided by the utility provider. The product can be purchased from a third party content provider, an aggregator of the content providers, a product from a mobile shopping site and the like. At step 304, the system 200 authenticates the confirmation received for payment. Further, at step 306, an evidence of the confirmation received is stored. At step 308, the system 200 submits the payment information for authorizing the payment from the subscriber account. The system 200 submits the payment information only when result of the authentication of the confirmation is positive. Finally at step 310, the system 200 provides the evidence to at least one of the subscriber, the utility provider (for example, mobile operator), and a provider of the product purchased.

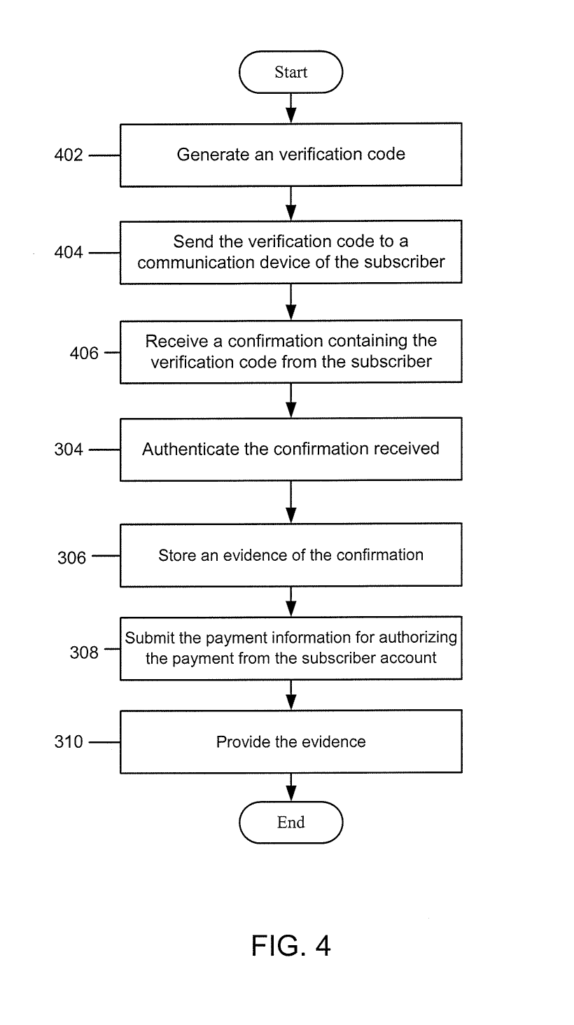

FIG. 4 shows a flow chart of a method for providing a real-time access to mobile commerce payment evidence, in accordance with another aspect of the present invention. At step 402, the system 200 generates a verification code by one of random or pre-specified rules. Further, at step 404, the system 200 sends the verification code to a communication device of the subscriber. Then, at step 406 the system 200 receives the confirmation containing the verification code from the subscriber. At step 304, the system 200 authenticates the confirmation received for payment. Further, at step 306, an evidence of the confirmation received is stored. At step 308, the system 200 submits the payment information for authorizing the payment from the subscriber account. The system 200 submits the payment information only when result of the authentication of the confirmation is positive. Finally at step 310, the system 200 provides the evidence to at least one of the subscriber, the utility provider (for example, mobile operator), and a provider of the product purchased.

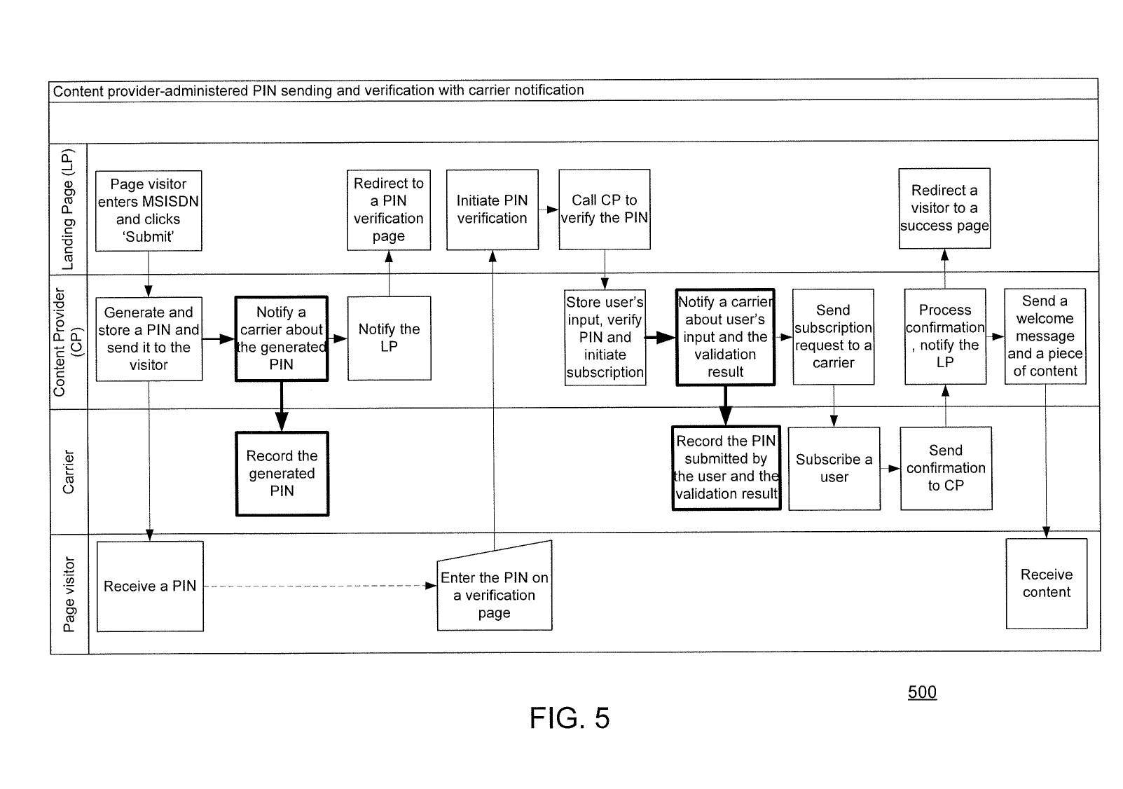

FIG. 5 illustrates a process flow 500 under which a mobile network operator has access to purchase confirmation evidence, in accordance with an aspect of the present invention. Client-customizable PIN verification pages are hosted on a trusted provider's (like an aggregator) servers in order to ensure other content providers or individuals can't tamper with them and entirely bypass PIN verification or loosen up the scrutiny. Mobile operator is informed about PIN verification and subscription results (either as a single event or as two separate events). The mobile operator is notified once or both when a PIN is generated and a PIN verification request is submitted by a user. The notification also includes the validation result of the verification.

It should be explicitly mentioned that the described modified double opt-in mechanism can be used for the on behalf of transactions when the aggregator or trusted provider processes transactions of other content providers. The figure does not depict the difference between a trusted content provider and just a content provider that is only allowed to perform transactions via said trusted content provider's APIs.

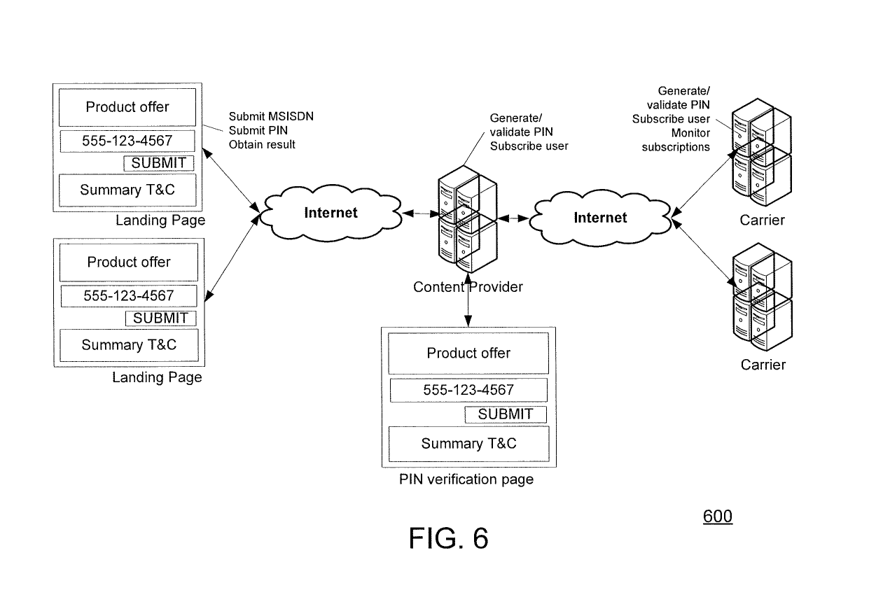

FIG. 6 illustrates a network environment 600 in which various aspects of the invention can be practiced. The figure emphasizes the possible geographic remoteness of landing pages, which can be hosted anywhere and PIN verification page(s), which can and should only be hosted on trusted content provider's servers as described in the process flow 500.

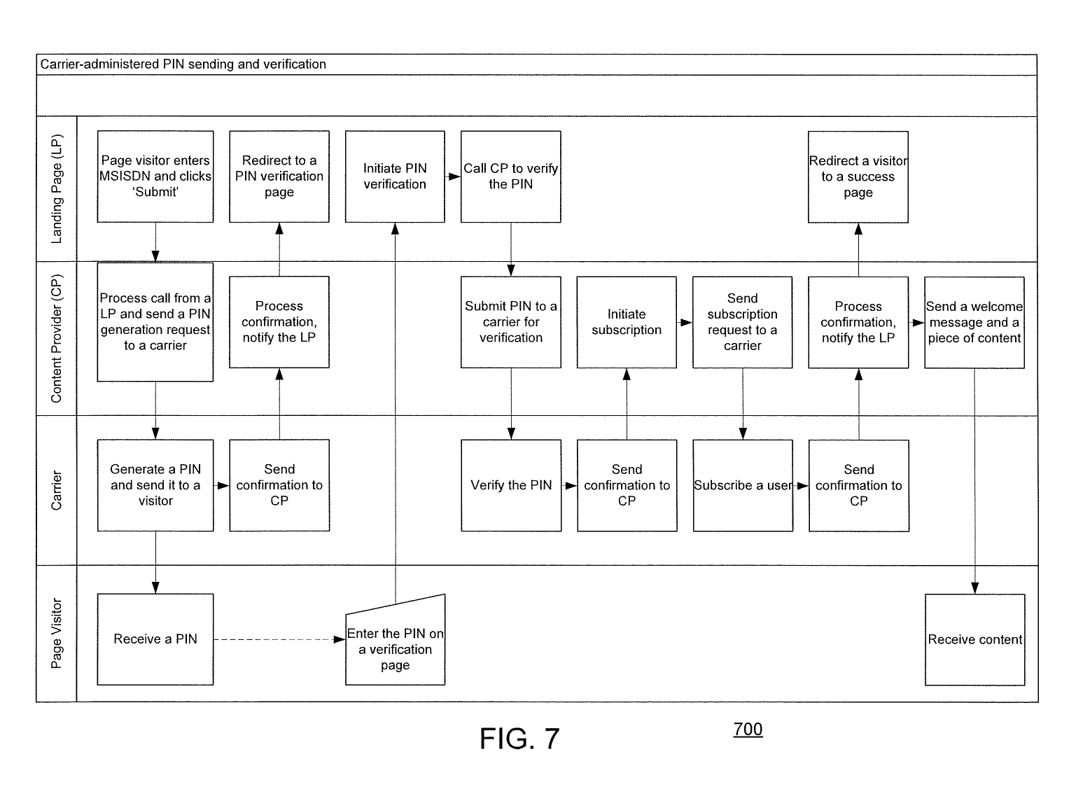

FIG. 7 illustrates a process flow 700 under which a mobile network operator has access to purchase confirmation evidence, in accordance with another aspect of the present invention. In the present aspect, mobile operators completely control the PIN generation, verification and monitoring, while still permitting content providers or aggregators to host and control the actual PIN confirmation page as part of the transaction flow that begins with their cell-number-submit pages.

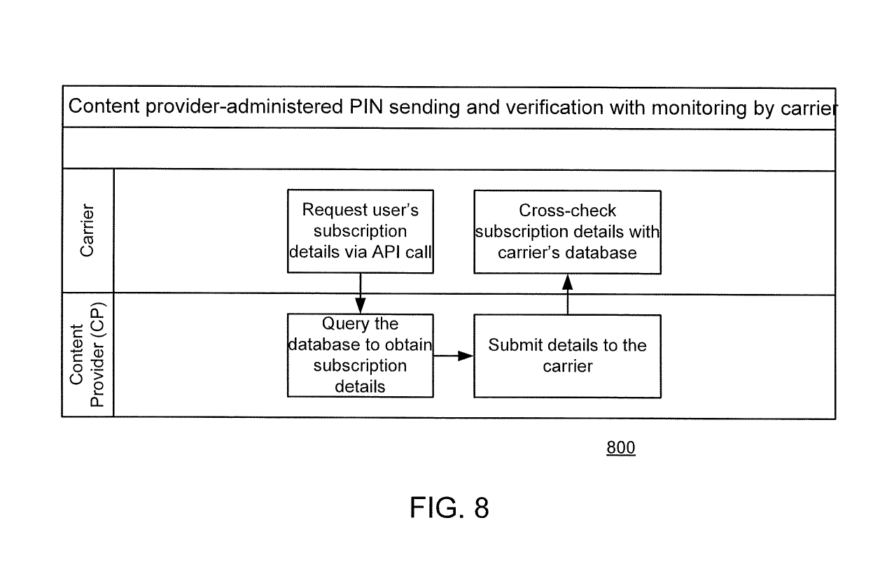

FIG. 8 illustrates a process flow 800 under which a mobile network operator has access to purchase confirmation evidence, in accordance with yet another aspect of the present invention. The process flow 800 does not require content providers to submit any notifications to carriers in real time, but rather opens up APIs (Application Programming Interfaces) or via reporting system. Ideally, such a system can be administered by large aggregators, so that each operator would only have to interface with a limited number of large PIN confirmation evidence databases, rather than with those created and maintained by a myriad of third party merchants.

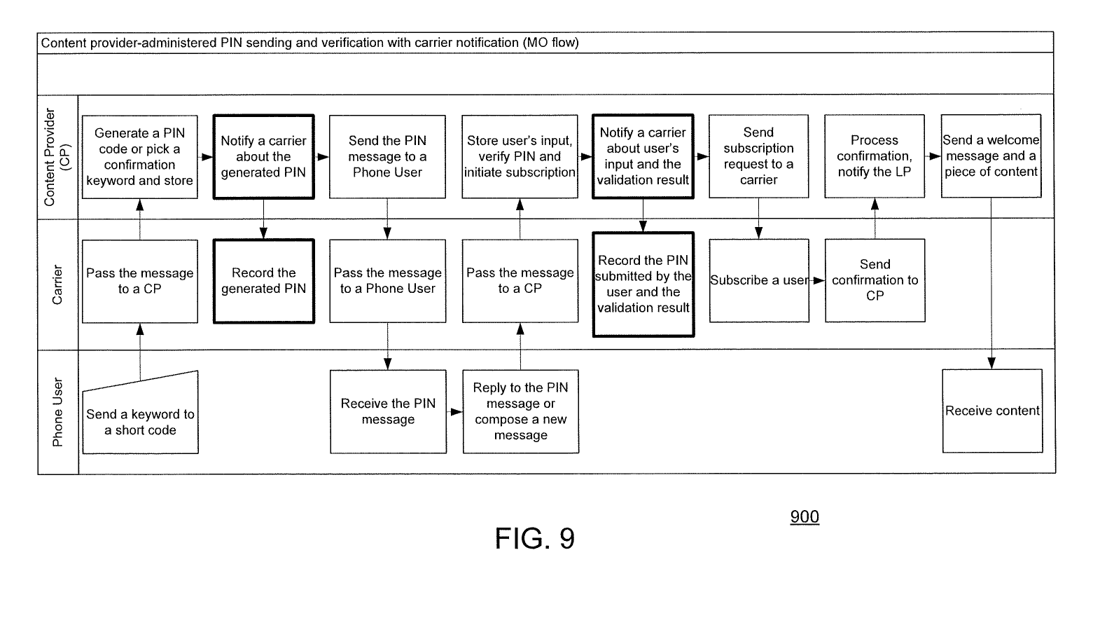

FIG. 9 illustrates a process flow 900 under which a mobile network operator has access to purchase confirmation evidence, in accordance with yet another aspect of the present invention. The process flow 900 allows notifying a mobile operator when a previously existing subscriber is unsubscribed from a subscription service. A typical scenario will look like:

User: sends a STOP message to a short code

Transactional System: receives the STOP message and unsubscribes the user from one or all recurring services said user has been subscribed to.

Transactional System: notifies the mobile operator about subscription termination (multiple notifications may be issued if the user was subscribed to multiple services)

Transactional System: notifies the user via SMS or via other allowed mechanisms about subscription termination.

It is possible for a trusted partner to perform subscription and keep the actual subscription database instead of relying on a carrier to maintain an actual copy of said database. In such cases even carriers without internal subscription databases can become customers of a trusted content provider (For example: Mobile Messenger). For MO and mixed opt-in mechanisms (i.e. when instead of typing a PIN in a web form a user has to reply with a specific SMS message) it's possible to notify carriers about the mixed opt-in prompt (a message like ‘Please reply with YES’ sent to the user) and about the result of user's response verification.

In an aspect of the present invention, the system for providing a real-time access to mobile commerce payment evidence can work with other sale/subscription mechanisms like IVR subscription.

The present invention adds a mechanism to ensure 100% transparency of every single transaction where a mobile operator is able to see on demand or receive in real-time, details of transaction's initiation (PIN delivery), PIN verification, subscription and possibly subscription termination. The invention also ensures that PIN verification system cannot be tampered with.

The invention allows carrier's customer support service representatives to be able to answer specific customers' questions about their subscriptions or purchases. Currently customers have to go directly to content providers to obtain such information. The traditional double opt-in mechanism gets improved in a way that:

Individual PINs are generated by a third party content provider or aggregator, and relevant (determined by mobile operator lookup or a similar mechanism) mobile operators are informed about such PINs and possibly about the whole PIN message contents before, during or after, a PIN message is sent to a would-be user. The notifications can be implemented by HTTP/API/Web Service calls or by similar mechanisms accepted by the mobile operators.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for providing real-time access to evidence of mobile commerce payments from a subscriber having an account with a utility operator, the method comprising:
receiving a confirmation of a mobile commerce payment by the subscriber purchasing a product, wherein the product is not purchased from the utility operator; authenticating the confirmation received;
storing evidence of the confirmation received; and
providing access to the evidence to the utility operator.

2. The method recited in claim 1, wherein receiving the confirmation comprises:
generating a verification code by one of random rules or pre-specified rules;
sending the verification code to a communication device of the subscriber;
and receiving the confirmation containing the verification code from the subscriber.

3. The method recited in claim 2, wherein the verification code comprises one or more of a numeric character, an alphabetic character and a special character.

4. The method recited in claim 2, wherein the communication device is one of a mobile phone, a computer, a laptop, an e-book reader, a netbook, and a Personal Digital Assistant (PDA).

5. The method recited in claim 2, wherein the verification code is received from one of a web page, a Wireless Access Protocol (WAP) page, a return message from the communication device, a telephone call, a Short Message Service (SMS) message and a Multimedia Messaging Service (MMS) message.

6. The method recited in claim 1, wherein the evidence comprises one or more of:
evidence of sending a verification code to the subscriber;
evidence of subscriber action to the verification code sent; and
evidence of outcome of the confirmation received from the subscriber.

7. The method recited in claim 6, wherein the outcome comprises one of a positive outcome, a negative outcome due to incorrect authentication code, a negative outcome due to duplicate transaction, a negative outcome due to the subscriber not being authorized to purchase the product, and a negative outcome due to timeout.

8. The method recited in claim 7, wherein access to the evidence is provided upon a positive outcome.

9. The method recited in claim 1, wherein providing the evidence comprises at least one of sending the evidence before authenticating the confirmation received, sending the evidence while authenticating the confirmation received and sending the evidence after authenticating the confirmation received.

10. The method recited in claim 1, wherein the product purchased is one of a third party content and a third party service.

11. The method recited in claim 1, wherein the evidence is for one of a one-time payment, a scheduled payment, a recurring payment, a subscription renewal, a subscription initiation and a cancellation of a subscription.

12. A system for providing a real-time access to evidence of mobile commerce payments from a subscriber having an account with a utility operator, the system comprising:
a confirmation module for receiving a confirmation of a mobile commerce payment by the subscriber purchasing a product, wherein the product is not purchased from the utility operator;
an authentication module for authenticating the confirmation received;
a memory module for storing evidence of the confirmation; and
an access module for providing access to the evidence and to the utility operator.

13. The system recited in claim 12, wherein the confirmation module comprises:
a code generation module for generating a plurality of verification codes by one of random rules or pre-specified rules;
a code sending module for sending one of the plurality of verification codes to a communication device of the subscriber; and
a code reception module for receiving the confirmation containing the verification code from the subscriber.

14. The confirmation module as recited in claim 13 further comprising:
a code database for storing the plurality of verification codes generated and a status of verification for each verification code of the plurality of verification codes.

15. The confirmation module as recited in claim 13, wherein the verification code comprises one or more of a numeric character, an alphabetic character and a special character.

16. The code reception module as recited in claim 13, wherein the verification code is received from one of a web page, a Wireless Access Protocol (WAP) page, a return message from the communication device, a telephone call, a Short Message Service (SMS) message and a Multimedia Messaging Service (MMS) message.

17. The system as recited in claim 12, wherein the evidence comprises one or more of:
evidence of sending a verification code to the subscriber;
evidence of subscriber action to the verification code sent; and
evidence of outcome of the confirmation received from the subscriber.

18. The system recited in claim 17, wherein the outcome comprises one of a positive outcome, a negative outcome due to incorrect authentication code, a negative outcome due to duplicate transaction, a negative outcome due to the subscriber not authorized to make a transaction, and a negative outcome due to timeout.

19. The system recited in claim 18, wherein access to the evidence is provided upon a positive outcome.

20. The system recited in claim 12, wherein providing the evidence comprises at least one of sending the evidence before authenticating the confirmation received, sending the evidence while authenticating the confirmation received and sending the evidence after authenticating the confirmation received.

21. The system recited in claim 12, wherein the product purchased is one of a third party content and a third party service.

22. The system recited in claim 12, wherein the evidence is for one of a one-time payment, a scheduled payment, a recurring payment, a subscription renewal, a subscription initiation and a cancellation of subscription.

23. The system recited in claim 12, the confirmation module further comprising:
a notification module for notifying a remote observer about each of the plurality of verification codes and the verification results of each of the plurality of verification codes.

24. The system recited in claim 12, wherein the verification module resides at a location remote from a location of the seller of the product.

25. The system recited in claim 12, wherein the code database is capable of being queried by a remote observer via one of an on-demand application programming interface calls and a reporting system.

26. A computer program product for use with a computer, the computer program product comprising a computer usable medium having a computer readable program code stored thereon for providing real-time access to evidence of mobile commerce payments from a subscriber having an account with a utility operator, the computer readable program code comprising:
receiving means for receiving a confirmation of a mobile commerce payment from the subscriber purchasing a product, wherein the product is not purchased from the utility operator;
authenticating means for authenticating the confirmation received;
storing means for storing an evidence of the confirmation received; and
access providing means for providing access to the evidence the utility operator.

27. The computer program product recited in claim 26, wherein the means for receiving comprises:
generating means for generating a verification code by one of random rules or pre-specified rules;
sending means for sending the verification code to a communication device of the subscriber; and
receiving means for receiving the confirmation containing the verification code from the subscriber.

28. The method of claim 1, wherein access to the evidence is provided to the utility operator and a seller of the product.

29. The method of claim 12, wherein access to the evidence is provided to the utility operator and a seller of the product.
